(19) United States
(12) Patent Application Publication
(10) Pub. No.: US 2004/0260751 A1
(43) Pub. Date: Dec. 23, 2004

(54) Method and apparatus for transferring software modules

(76) Inventor: Berthold Schloesser, Ehningen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/482,588

(22) PCT Filed: Jun. 25, 2002
(86) PCT No.: PCT/EP02/06995

(30) Foreign Application Priority Data
Jun. 28, 2001 (DE) 101 13 394.2

(51) Int. Cl. G06F 15/16

(52) U.S. Cl. 709/200

(57) ABSTRACT

The invention relates to a method for transferring software modules for target units on board a mobile apparatus, preferably a vehicle or means of transport. A mobile memory device, for example CDs, stores information regarding which software modules are approved for which types of target units on the mobile apparatuses. This information is compared, prior to transfer, with the configuration of the mobile apparatus. As a result, the method permits increased process certainty. The method can be carried out for transfer both with and without a connection between a mobile apparatus and a central configuration management system or documentation system.

### BACKGROUND AND SUMMARY OF THE INVENTION

This application claims the priority of International Application No. PCT/EP02/06995, filed Jun. 25, 2002, and German Patent Document No. 101 31 394.2, filed Jun. 28, 2001, the disclosures of which are expressly incorporated by reference herein.

The present invention relates to a method and apparatus for transferring software modules for target units which are fitted in a target apparatus. The target apparatus is a mobile apparatus, preferably a vehicle or means of transport.

In mobile apparatuses, particularly in motor vehicles, an increasing number of units which are controlled by software modules are used, e.g., door control units. Some units, such as electronic navigation systems and systems for voice output, require extensive data libraries. To match mobile apparatuses to individual requirements and desires from users or operators, target units in many different variants are often manufactured and fitted, sometimes retrospectively. The combination of variants gives rise to a large number of different configurations for target units on board mobile apparatuses which belong to a family of mobile apparatuses. Nevertheless, the manufacturer of a mobile apparatus needs to ensure that these target units interact with certainty in the course of operation in any combination which he has approved.

“Software modules” refers, in particular, to programs or portions of programs which are executed on board mobile apparatuses and to data for such programs or for units. “Target units” refers to those units on board a mobile apparatus for which software modules need to be transferred, and these include data-processing units in particular.

It is still customary today, for the purpose of retrospectively transferring software modules to mobile apparatuses, to remove the target units in a workshop, for example, to provide them with the desired software modules and then to refit them. In some cases, it is even necessary to send the target unit to the manufacturer, who transfers the software modules centrally. These methods are expensive and time consuming.

Methods are known for installing data for a navigation system on board a vehicle from a CD. In the case of the system TravelPilot from Bosch/Blaupunkt, the car driver visits a workshop. There, data for a navigation system which interacts with a car radio are read in from a CD. Some navigation systems read in digital maps from a CD at the time of running, that is to say during a car journey. All of these systems and methods are tailored to target units from one particular manufacturer. There is no disclosure of how the method can also be applied if software modules for target units from different manufacturers need to be installed. There is only the way of applying the method a plurality of times, namely once per manufacturer or even once per unit. There is no way of ensuring that just the correct and no other software modules are transferred. In this context, “correct” refers to those software modules which are approved for the combination of target units which is actually present in the vehicle. In particular, it is not possible to prevent a software module from a manufacturer from impermissibly influencing the overall configuration of units which is actually present on board the mobile apparatus.

A method in line with precharacterizing is known from German Patent Document No. DE 689 204 62 T2, the German translation of EP 333620 B1. The object of German Patent Document No. DE 689 204 62 T2 is online problem solving in a customer system by a central remote servicing system.

A problem management database receives service requests as search arguments and delivers approaches to solutions for troubleshooting. It contains entries which connect a multiplicity of components and symptoms in the form of search arguments and problem solutions to one another as output data. Preferably, the problem management database comprises three separate units, namely a symptom exception table with entries for hardware components, an APAR table for software components with provisional program corrections, and an MTAR table with corrections for microcode. The search arguments are preferably symptom consequences, which are formatted as reference keys, which distinguish interchangeable components (“field replaceable units”, FRUs), and distinguish the number and exit point for a problem solving method. By way of example, the symptom consequence comprises the two most probable errors.

The problem management database from German Patent Document No. DE 689 204 62 T2 requires symptoms, revealed as search arguments, and exit points from problem finding methods. A service request distinguishes a particular customer system and results of the problem finding method. The problem management database is constructed such that its output data stipulate the solution to the problem.

The problem management database is necessarily complex, and its evaluation requires some computation time. This is because a component can generally be disrupted by different errors, and an error on one component can cause errors on other components. This means that there are usually far more symptoms to take into account than components which are present.

Before the transfer of software modules, German Patent Document No. DE 689 204 62 T2 involves accessing configuration data for the target apparatus. The configuration of the hardware and software components at the time of the fault is acquired by this means. These configuration data are managed by a resource manager system, preferably in a table. Mobile apparatuses are often not able—e.g. on account of lack of storage capacity on board—to manage such a table on board and to keep it up to date, or can do so only with some complexity. Particularly in the case of mobile apparatuses, there is also the risk that the table's configuration does not match the actual configuration of the target apparatus because a user or operator of the mobile apparatus is replacing or adding to a target unit. Such an operator or user is generally not an expert in data processing, but rather a car driver, for example. It therefore cannot be assumed that a configuration table always contains the current configuration of the mobile apparatus.

German Patent Document No. DE 195 320 67 C1 discloses a method and a device for programming operating data into vehicle components. The data are sent from a control center to a requesting station, e.g. a motor vehicle. The control center codes the data using an individual code relating to the vehicle component. The data are not decoded until in the vehicle component itself. This protects the data from unauthorized access. In line with one refinement, information about the identity of the vehicle, of the vehicle component and of the requesting system user is transmitted to the control center, where the request is checked for authorization.

German Patent Document No. DE 197 50 372 A1 discloses a method for loading programs and/or data. The programs and/or data are downloaded from a supplier's server, in which case a radio link is set up between the target unit and the server and is used to transfer the programs or data following a successful check on access authorization. This method requires a transmission and reception device on board the vehicle. Much time is needed if the software modules are more extensive. The transfer time depends on the bandwidth of the radio link. It increases unpredictably if the transfer link is overloaded by a large volume of data or is disrupted.

German Patent Document No. DE 42 18 804 A1 discloses a device for displaying, editing and storing information in a motor vehicle. The device comprises a bulk memory for nonvolatile storage of programs and data, interfaces for receiving information, an operator control unit, a display unit and an operating system on which programs can run. The inventive device allows functions of units on board to be flexibly aligned and extended. In one refinement, it comprises a CD player. In addition, the device can comprise means for preventing unauthorized input of data and for providing data to be input on an authorized basis with an approval identifier. Such an approval identifier can be checked, by way of example, using stored code. This device can check whether a software module is approved for a particular user or for a particular vehicle.

The control device from EP 392411 B2 comprises a system manager with a computer and memory and also apparatuses for identifying a user. The identification apparatus includes a reading unit which reads in a portable recording medium, e.g. a chip card, and checks whether the recording medium is being used validly and correctly. Only if the check is positive is a program stored in the memory executed. The user can also select specifications for control units, and the specifications are stored on the recording medium. This allows the response of particular control units to be aligned with a particular authorized user.

U.S. Pat. No. 6,009,363 discloses a computer system on board a vehicle which comprises two logic units between which data can be interchanged, with a data bit indicating, as a check bit, whether the rest of the data transferred to the vehicle are valid. The document discloses a way of installing software modules in memories on board a vehicle and of checking whether the data are transferred correctly, i.e. without transfer errors.

The aforementioned printed documents disclose methods for transmitting software modules to a mobile apparatus and, in so doing, for carrying out authorization and approval checks when required. The checks respectively relate to a single mobile apparatus. However, the methods do not allow for the possibility that software modules may need to be transferred to mobile apparatuses which have many variants. By way of example, the wide range of variants results from various exemplars of a family of mobile apparatuses having different target units fitted or from target units being used in different versions. The wide range of variants can result in an enormous number of different checks, which cannot be defined and validated with a reasonable level of involvement. In addition, there is no allowance for the fact that a user or operator of a mobile apparatus can replace or retrospectively add to a target unit without informing the manufacturer of the mobile apparatus of this and without said manufacturer being able to take this into account in an approval check based on the prior art. However, it is necessary to allow for a wide range of variants and retrospective changes in order to ensure that the correct software modules are transferred to each mobile apparatus.

The present invention is based on the object of providing a precharacterizing method which ensures that only the correct and no other software modules are transferred even when variant-rich families of target apparatuses with target units from various manufacturers are present or when it is necessary to allow for the possibility of retrospective changes on individual target apparatuses, about which the control center has no information. The present invention is also intended to provide an apparatus for carrying out the method.

The object is achieved in various embodiments of the present invention as specified herein.

A preferred method in accordance with the present invention transfers software modules for target units. The target units are fitted in a mobile apparatus, particularly in a vehicle or means of transport. The software modules are stored in a mobile memory device, for example on a CD. A data link is set up at least intermittently between the mobile memory device and the mobile apparatus, e.g. by connecting a reader for CDs, which is fitted in the mobile apparatus, to a target unit via a data bus. This data link is intended for the purpose of transferring the software modules. A check is carried out to determine which software modules are approved for the mobile apparatus.

Two kinds of type identifiers are stipulated. First, unit-type identifiers are stipulated for target units, and secondly software-type identifiers are stipulated for software modules. The unit-type identifiers and software-type identifiers are used to stipulate which of the stored software modules are approved for which types of target units. A software module is approved for a target-unit type at least if the software module can be executed on any target unit of the type. These approval stipulations are stored on the mobile memory device, for example.

The preferred method also provides for the type of at least one target unit which is actually fitted at the time of the transfer to be ascertained. For at least one software module, a check is carried out to determine whether the software module is approved for the type of the actually fitted target unit. The software modules recognized as approved are transferred to the mobile apparatus. They are preferably stored on board the mobile apparatus, for example in the respective target unit in an overwritable memory or in a central memory device on board.

The method can be applied in the same way for families of mobile apparatuses which comprise a small number of variants as for families of mobile apparatuses which comprise a large number of variants. In particular, the correct, and no other, software modules are reliably selected and transferred, even if the mobile apparatus contains a plurality of target units from different manufacturers and these target units are present in different versions which require different software modules. The approval stipulations are produced for types of target units and software modules, not for individual mobile apparatuses. The approval stipulations are therefore not dependent on the actually existing configuration of a mobile apparatus.

The same mobile memory device can store software modules for target units from various manufacturers and also for various versions of target units. This means that the mobile memory device can be used without alteration or alignment for any exemplar in a family of mobile apparatuses, even when there is a large number of variants.

The correct software modules are selected and transferred even if a user or operator of the mobile apparatus has retrospectively replaced a target unit with another kind or has retrospectively added a further target unit or has removed one. This is achieved, in particular, by ascertaining which types of target units are actually in the mobile apparatus at the time of the transfer. It is no longer necessary to carry out a check in a central database with configurations for mobile apparatuses. The entries in such a central database may be outdated, e.g. because a target unit has been replaced with another kind, has been added or has been removed without the associated entry having been updated accordingly.

The invention can be used to transfer software modules to the mobile apparatus much more quickly than if the software modules were not sent from a central server to the mobile apparatus until the time of the transfer. For example, if a CD-ROM is used as a mobile memory device, then just single reading speed achieves a data transfer rate of 170 kbytes/sec. From a DVD as a further possible mobile memory device, it is even possible to read at 500 kbytes/sec and above. In addition, the method is much less susceptible to faults than transfer directly from a control center to the mobile apparatus. The time requirement for transfer can actually be predicted just in the knowledge of the data transfer rate from the mobile memory device to the mobile apparatus.

The method can be used in various refinements for different applications, for example for those applications described below.

In one application, a manufacturer has produced hundreds of vehicles of one type. Each vehicle is fitted with a target unit of one particular type. Not until immediately before the vehicles are delivered to the dealers are software modules produced and approved for this type of target unit. The inventive method allows these software modules to be transferred quickly and “at the last moment” before delivery without the need to remove a target unit or to set up a data link, e.g. to a central server. The transfer of software modules can be automated, for example by virtue of robots placing CDs with the software modules and approval stipulations into readers units on board the vehicles, starting the transfer operation and removing the CDs again when transfer is complete.

Following delivery of a family of vehicles, new software modules are produced and approved for a particular type of target units. Target units of this type have been installed in various variants in numerous instances of the vehicles, and different software modules have been approved for these variants. All installed target units need to be provided with the respectively approved software modules, e.g. in order to satisfy new legal provisions. To this end, workshops and/or further service partners of the vehicle manufacturer are supplied with the respective data storage medium storing the software modules for all variants of the target unit, in line with the invention. The users of the vehicles in question are asked to visit one of these workshops. The inventive method transfers the correct software modules, and there is no possibility of software modules being transferred which have not been approved for the target units in a particular vehicle. Since no data link to a control center is set up for the transfer, transfer requires only a little time and is not dependent on the availability of a long-haul data network.

Following the transfer, the workshop preferably carries out a function test in order to check whether the transfer has been concluded successfully. A central configuration management system or a documentation system receives a report stating which software modules are on this vehicle following the transfer. In this way, the vehicle manufacturer meets his demands on the product documentation.

One type of target unit is provided in two variants: with and or without a particular functionality. The two types differ only by virtue of software modules. This approach reduces the diversity of variants among target units. The additional functionality is provided by transferring these software modules to the vehicle. The inventive method allows the vehicle manufacturer to provide an owner of the vehicle with the option of implementing the additional functionality at the very start of use or else any time afterwards. This is done by virtue of the owner acquiring a data storage medium with the software modules and intermittently connecting it to the vehicle. The inventive method transfers the software modules and thereby implements the additional functionality without the need for the vehicle to be taken to a workshop or for the target unit to be removed.

A vehicle is fitted with a system for voice output which outputs messages and information to the driver in natural language by reading aloud. The driver selects which language this is to be in. Since this gives him the choice of a large number of different languages and since the data required just for reading aloud a natural language take up a large amount of storage space, it is uneconomical to store all the voice data for every language offered permanently in a vehicle. In line with one refinement of the inventive method, the software modules, particularly the voice data and programs for all the languages offered, are stored on a single data storage medium. Following selection of a language, the software modules required for output in this language are transferred to the vehicle. There is no need for a separate data storage medium to be kept for each language or for data or programs to be transferred for a language other than the selected one. The method can be repeated at any time without visiting a workshop when output in a different language is desired, for example because the vehicle has changed owner or driver. A frequent change of driver occurs particularly in the case of vehicles which are hired out on an hourly or daily basis by a car hire firm or in the case of commercial vehicles belonging to a transport company.

A similar refinement can be used to transfer the software modules which are required for a system for voice input. Such a system recognizes commands from the driver or else from a service engineer which are spoken in natural language, in order to control a unit on board the vehicle.

The mobile memory device on which the software modules are stored preferably comprises

at least one CD

and/or at least one Minidisc, which is a 3.5 inch data storage medium originally developed for MP3 data,

and/or at least one DVD,

and/or at least one flash memory stick.

Following the completion of storage of the software modules, a CD which is part of the mobile memory device is preferably completed as an ISO-9660 medium.

In another refinement, the mobile memory device is part of a portable computer, preferably a hard disk in the computer or a CD which is placed into a CD drive in the computer. This portable computer is connected at least intermittently to the control device, for example using a commercially available parallel cable for the purpose of data transfer.

Preferably, a type identifier comprises an article number and a version number. The versions of one type all perform the same function and can be interchanged with one another, and in particular are upwardly and downwardly compatible.

The refinement in line with a second preferred embodiment allows software modules to be transferred to a plurality of mobile apparatuses having different target units. By way of example, some target units are present in only a few of these mobile apparatuses, or various mobile apparatuses are fitted with different types of target units. Nevertheless, the same mobile memory device or a plurality of similar mobile memory devices are used for each of these mobile apparatuses. By way of example, the mobile memory device has as many copies produced as there are mobile apparatuses. Evaluation of the approval stipulations ensures that, despite different configurations, the correct software modules are transferred to each mobile apparatus.

To store the software modules for target units from various manufacturers efficiently on the mobile memory device, memory areas are advantageously reserved for particular manufacturers. In line with a third embodiment, for at least two manufacturers of target units, a respective memory area is reserved on the mobile memory device for the software modules for target units from this manufacturer.

Advantageously, software modules for target units from various manufacturers are stored together with approval stipulations for these software modules on the same mobile memory device. In line with a third embodiment,

software modules for target units from a first manufacturer are stored at a first location on the mobile memory device,

software modules for target units from a second manufacturer are stored at a second location on the mobile memory device,

approval stipulations for the software modules for target units from the first manufacturer are combined with approval stipulations for the software modules for target units from the second manufacturer,

and the combined approval stipulations are stored on the mobile memory device.

The approval stipulations are stored, by way of example, in ASCII format, a binary format or preferably using the extended Markup Language (XML).

The approval stipulations are preferably stored on the mobile memory device. As a result, they are available for the approval checks at the time of the transfer without any further method steps. Preferably, the mobile memory device stores, for at least one software module, information about the location at which the software module is stored on the mobile memory device. By way of example, the location information comprises a path for the software module and, for each file of the software module, a subpath relative to the path. In addition, when a software module is stored in a target unit, a start address for a memory area for this target unit type is stored, specifically preferably on the mobile memory device.

One alternative to storing the approval stipulations on the mobile memory device is for the approval stipulations to be stored in a configuration management system or in a documentation system. The transfer of the software modules is controlled by a control device. The approval stipulations are transmitted from the configuration management system or the documentation system to the control device. This refinement has the advantage that the approval stipulations do not need to be produced until at the time at which transfer of the software modules starts, that is to say, by way of example, after the mobile memory devices have been distributed to workshops.

In one embodiment, a software module is approved for a target unit type under all circumstances, i.e. regardless of what further target units are fitted in the mobile apparatus. However, target units on board can influence one another. For this reason, another embodiment links approval to a condition. Only if the condition is satisfied is the software module approved for the mobile apparatus. In line with one embodiment, the approval stipulations comprise at least one condition for approving a software module. The approval check for this software module involves checking the validity of the approval condition.

Such an approval condition preferably comprises the presence and/or absence of particular target-unit types and/or of particular software modules on board the mobile apparatus. By way of example, a software module is approved for a target-unit type A only if a target unit of type B and no target unit of type C is fitted on board the mobile apparatus. An approval condition is preferably a Boolean expression containing unit-type identifiers and/or software-type identifiers. An approval condition is stored in the form of a table or a database, for example.

One embodiment for approval stipulations involves an actual interface specification being stipulated for a software module, and there is also a stipulation of what nominal interface specification is expected by a target-unit type. For a software module, one or more actual interface specifications are stipulated, and for a target-unit type one or more nominal interface specifications. Only if the actual interface specifications are compatible with the nominal interface specifications is the software module approved for the target unit type. Preferably, approval stipulations for which software-type identifiers and unit-type identifiers are used are combined with approval stipulations using actual and nominal interface specifications.

Interface specifications are known, by way of example, from the programming languages C, C++ and PASCAL by the names “Procedure declarations” and “Method declarations” and also from JAVA by the name “Interface”. A simple example of a nominal interface specification is one stating that the target-unit type expects a function called “Sort”, which has a natural number n and a vector with n integers as input variables and, as an output variable, has a vector for which the n integers of the input vector are sorted in rising order. The interface specification does not stipulate which sorting method is applied. An actual interface specification, according to which a vector with n real numbers is sorted, is compatible with this nominal specification. Further examples of interface specifications are the specification of a TCP/IP stack and the specification of functions for a transfer channel, e.g. an audio or video channel. These functions set up the connection to the transfer channel, open it, perform data transfer and close it again. The interface specification can be dependent on the kind of transfer method.

A further embodiment for approval stipulations is based on an earliest approval time, for example the day from which the software module is approved. For a software module, there is stipulation regarding the date from which this software module is approved. The approval check involves comparing the earliest approval time with the time at which software modules are transferred to the mobile apparatus. Generally, only when the transfer time is the same as or later than the earliest approval time is the software module assessed as approved. Preferably, comparison of the times is followed by evaluation of the approval stipulations using software-type and unit-type identifiers, because comparing times requires less computation time than an approval check.

One refinement of the inventive method is that an approval check is carried out for each software module on the mobile apparatus, and each software module recognized as approved is transferred. By contrast, the refinement in line with a further embodiment makes provision for a set of software modules to be prescribed. Only the software modules in this set are considered for transfer, and the others are not even if they are approved. For each software module in the set, an approval check is carried out. Each software module recognized as approved in the set is transferred from the mobile memory device to the mobile apparatus. This means that it is possible to use the same mobile memory device or a plurality of similar memory devices for transferring various software modules. This requires merely a respective new set to be prescribed.

By way of example, the set is prescribed by virtue of particular software modules being distinguished on the mobile memory device. All distinguished software modules belong to the set. The distinction is made, by way of example, by listing the software-type identifiers for the software modules which are to be distinguished.

In another embodiment, the set is prescribed by virtue of particular software modules being distinguished in a configuration management system or a documentation system. The transfer is controlled by a control device. The information about which software modules belong to the set is transmitted from the configuration management system or the documentation system to the control device. By way of example, a set of software-type identifiers is transferred to the control device. This refinement allows the set to be stipulated only directly before the transfer.

The refinement in line with this embodiment is advantageous particularly when at least one target unit is part of a voice-input or voice-output system on board the mobile apparatus. In this case, the mobile memory device stores software modules for various languages. The set is prescribed by virtue of a language being selected. Preferably, the mobile memory device stores stipulations regarding which software modules belong to which language. By way of example, a set of software-type identifiers is listed for each language.

To prevent a software module from having been corrupted or manipulated, for example upon storage on the mobile memory device or upon transfer, or to prevent a copy produced without authorization from having been used, a correctness check is carried out. This involves producing a signature for at least one software module and storing it on the mobile memory device. The signature is preferably produced by treating the software module as a data stream and producing a hash value. A secret key is used to produce the signature from this hash value. The signature is thus dependent on the software module and on the secret key.

In addition, a public key is stored on board the mobile apparatus for at least one target-unit type. This public key is used to check the signature. Only if the result of the check is positive is the software module recognized as uncorrupted and as authorized.

The refinement described below can be applied particularly when particular software modules are to be transferred only if the user of the mobile apparatus is authorized to own the software modules. By way of example, the software modules are transferred only if the user has paid a purchase price for them, but not if the user has come to own the mobile memory device without authorization. The refinement provides for identification data for a user to be acquired. By way of example, a user types in a password. The identification data are used to carry out an authorization check for the user, for example the password typed in is compared with a stored password. At least one software module is transferred only if the authorization check delivers a positive result.

Preferably, the software modules themselves are not encrypted, because encryption would require vehicle-specific mobile memory devices to be produced. The use of a signature protects the software modules, and a mobile memory device can nevertheless be used for different types and for a plurality of exemplars of mobile apparatuses.

Provision is preferably made for at least one software module to comprise audio and/or video data. These audio and/or video data are used in order to explain to a user how to operate the mobile apparatus or a fitted target unit. By way of example, operation of a unit is explained to the user by means of a video film, or an explanatory text is read aloud to him. Since these data, like all other data associated with software modules, are also subjected to an approval check, it is certain that only the correct audio and/or video data are transferred, that is to say only such data as relate to an actually fitted target unit.

Playback of the audio and/or video data is started, by way of example, when the user so desires or when transfer of the software modules has been completed successfully. Preferably, the mobile memory device stores menu items which are displayed to the user so that he can select a menu item in order to stipulate which audio and/or video data are played back.

In line with a further embodiment, an apparatus for carrying out the inventive method comprises

a reader for reading in software modules and approval stipulations from a mobile memory device,

and a control device which controls the transmission of software modules from the mobile memory device to the mobile apparatus and, in so doing, checks which software modules are approved for the mobile apparatus.

The reader for the mobile memory device is preferably present on board the mobile apparatus, for example it is a CD reader.

### BRIEF DESCRIPTION OF THE DRAWINGS

An exemplary embodiment of the inventive method is described in more detail below with reference to the appended drawing, in which:

FIG. 1 shows an exemplary embodiment of the invention using CDs as mobile memory devices.

### DETAILED DESCRIPTION OF THE DRAWINGS

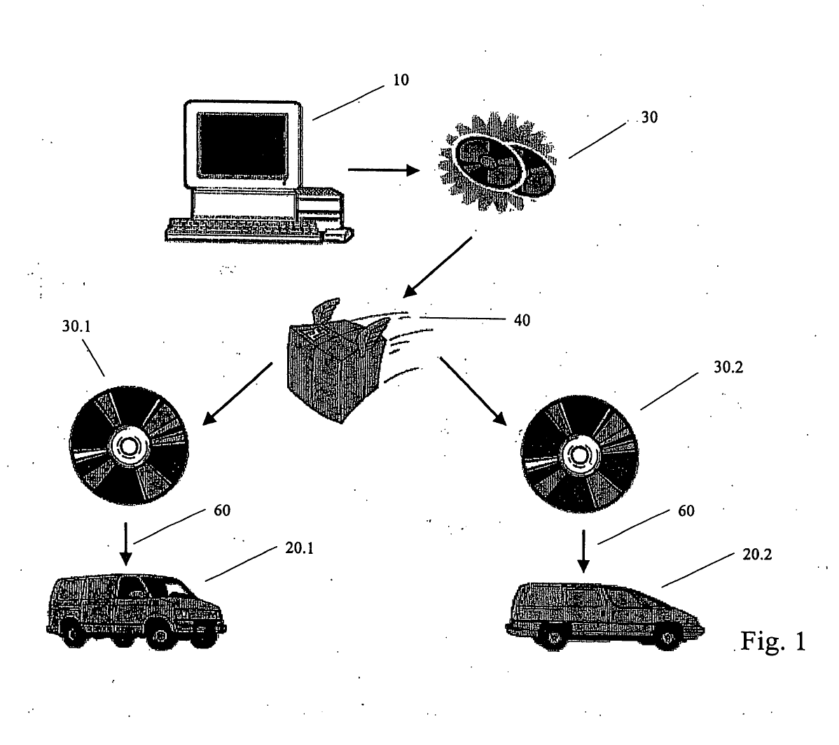

In the example in FIG. 1, two motor vehicles 20.1 and 20.2 are supplied with software modules. As mobile memory devices with the software modules, the example in FIG. 1 uses two CDs 30.1 and 30.2. A control center 10 produces the two similar CDs, for example by copying. They are delivered, by way of example, to the drivers of the two vehicles 20.1 and 20.2 or to two workshops by mail. Using two CD readers, the software modules are transferred from the CDs 30.1 and 30.2 to the two vehicles 20.1 and 20.2, respectively. The CD readers provide a data link 60 between the CDs 30.1 and 30.2 and the motor vehicles 20.1 and 20.2, respectively.

The invention is described with reference to an exemplary embodiment in which two target units on board a motor vehicle 20 are supplied with software modules: a central unit in a system for voice output, which reads aloud messages to the driver in natural language, for example, and a control unit for the door system. The central unit comprises a reader for CDs and is connected by means of a data bus to the control unit and also by means of a data link to a control device which controls and monitors the transfer operation. In this embodiment, the CDs 30 are thus used as mobile memory device. These CDs can have information written to them once or a plurality of times (CD-R or CD-RW). A few of the alternative embodiments for the mobile memory device 30 are DVDs, memory sticks with a USB interface or a portable computer (laptop, palmtop). Depending on the embodiment, the control device is located on board a vehicle 20.1, 20.2 or else outside of a vehicle 20.1, 20.2, and is in that case connected to the central unit preferably only intermittently.

The two target units come from different manufacturers and appear in various versions. The voice output is intended to be possible in a plurality of languages. Each language requires three software modules, for example. The software modules for all the variants of the two target units are stored in a CD. The storage operation is completed in line with the ISO-9660 medium standard, for example.

The type of a target unit and that of a software module are distinguished by a respective article number, which is a sequence of digits and letters which is unique within the vehicle manufacturer's product range. The variant is distinguished by a three-digit number.

In the example described, all the software modules considered for transfer are stored on a single CD. This CD holds three files:

An approval file with the approval information for software modules which are evaluated when software modules are checked,

A menu file which contains information which a unit in the system for voice output uses to construct a selection menu which the user uses to select a language for the voice output, and

An autostart file which prescribes the software modules to be transferred if neither a second set of software modules is prescribed by a configuration management system or a documentation system nor a user makes a selection.

Preferably, these three files have stipulated names, e.g. the three names CD INFO.CDI, MENU.CDI and CONFIG.CDI, and are stored at a particular location on the mobile memory device.

The software modules are stored on the CD in paths (directories) in a file management system, which are known from a large number of operating systems. A path comprises a plurality of components which are respectively separated by a separating character (delimiter). By way of example, the vehicle manufacturer stipulates the first four components of such a path, specifically in the following order: supplier—regional validity of the software modules—type of the software modules—versions. Two examples:

The four path components /XY/EUR/OS/V1 bring together the software modules from supplier XY, which are approved for target units on the European market, which are operating systems (OSs) and are in version V1.

The four path components /AB/USA/EXE/V2 bring together the software modules from supplier AB, which are approved for target units on the US market, which are executable programs and are in version V2.

The further components of the path and also the file names, which describe the storage location, are appended after the four prescribed components.

The approval file describes the approval information and also the storage locations of software modules in line with a particular syntax, which is explained below using an example. One principle is that a software module is approved for a type of target unit only when corresponding approval information has been noted in the approval file, otherwise it is not.

The approval file contains the following lines:

CD name 123456789-001
{
# central unit for Europe
[HW-1001-001] [HW-1001-002];
# operating system for central unit
[SW-101-001] /XY/EUR/OS/V1;
# application for central unit
[SW-111-001] /XY/EUR/APPL/V1;
}
{
# central unit for USA
[HW-1002-001] [HW-1002-002];
# operating system for central unit
[SW-102-001] /XY/USA/OS/V1;
# application for central unit
[SW-112-001] /XY/USA/APPL/V1;
}
{
# door control unit for Europe
[HW-2001-001] [HW-2001-002];
# operating system for door control unit
[SW-201-001/ /AB/EUR/OS/V1;
# application for door control unit
[SW-211-001] /AB/EUR/APPL/V1;
# diagnosis for door control unit
[SW-221-001] /AB/EUR/TOOL/V1;
}
{
# door control unit for USA
[HW-2002-001] [HW-2002-002];
# operating system for door control unit
[SW-202-001] /FG/USA/OS/V1;
# application for door control unit
[SW-212-001] /FG/USA/APPL/V1;
# diagnosis for door control unit
[SW-222-001] /FG/USA/TOOL/V1;
}
{
[Common]
[HW-1002-001] [HW-1002-002] [HW-2002-001] [HW-2002-002];
# specific application for USA
[SW-3001-002] /FG/USA/TOOL/VS/SPEC;
}

In this example, the software for the central unit comes from the supplier XY, and that for the door control unit comes from the suppliers AB (for the European market) and FG (for the US market). Target-unit types and software modules are distinguished by article numbers starting with HW and SW, respectively, followed by three or four digits. Versions are distinguished by three digits. SW-212-001 denotes, by way of example, a software module with the article number SW-212 and the version number 001. Article numbers and versions are in square brackets [ ]. Remark lines start with a #.

The CD on which these software modules are stored has, itself, an article number and a version number which are stated at the beginning after the key word “CD name”. The approval file stipulates, by way of example, that the software module SW-212-001 is approved for versions 001 and 002 of the target unit with the article number HW-2002, and the associated files are stored in the path /FG/USA/APPL/V1. For versions 001 and 002 of the door control unit, the software modules SW-202, SW-212 and SW-222 are approved, specifically version 001 in each case.

The key word “common” starts an area having stipulations which approve software modules for various kinds of target unit. In this example, version 002 of the software module SW-3001 is approved for the versions 001 and 002 of the target-unit type HW-1002 and versions 001 and 002 of the target-unit type HW-2002.

Evaluation of the approval file involves the approval file being searched for each target unit occurring in the vehicle. If this reveals the article number and version number of the target-unit type in the first line after an opening curly bracket, then all the software modules stated up to the next closing bracket are approved for this target unit. Preferably, the search in the approval file is continued in blocks which start with the key word “common”.

An approval file can be automatically compiled

from information about approvals which are provided by the individual suppliers of software modules,

from the prescribed first four components of the path in which software modules are stored, and also from associations between software modules and these paths,

and from the article number and version number of the CD.

The CDs can store software modules from any number of suppliers for any target units.

In one embodiment of the invention, a central configuration management system or a documentation system prescribes a second set of software modules which are transferred to the vehicle. Each software module from this second set which is approved for at least one target unit on board the vehicle is transferred. In this embodiment, the menu file and the autostart file are not required.

The information stored in the menu file is evaluated in order to explain to a user the alternatives for a selection. This selection gives the user the option of selecting one or more groups of software modules without having to select individual files directly himself.

One exemplary application involves a user selecting the natural language in which messages are read aloud to him. The central unit includes a component for man/machine interaction which a user uses to select an alternative from a prescribed menu, e.g. by pressing a key or touching the screen. The user first selects one of a plurality of possible applications, e.g. he chooses between “voice output”, “voice input” and “abort” (the selection). The “style guide”, that is to say the information stipulating the appearance of the menus, is stored in the central unit itself, for example. The menu items are stored on the CD and/or in the central unit. By way of example, the menu items “voice output” and “voice input” are stored on the CD, whereas the standard menu item “abort” is stored in the central unit.

The “voice output” alternative is linked to information on a CD. By way of example, this link is set up using the key word “T2S” (text-to-speech). The “voice output” alternative is likewise linked to “T2S” by information which is stored in the central unit, and the menu file on a CD stores information which starts with the key word T2S.

The menu file contains the following lines, for example:

| | |
|---|---|
| { | |
| [Auto-Menu] | |
| [HW-1001-1001] [HW-1001-002]; | |
| [T2S]; | |
| “Deutsch” | [SW-555-001]; |
| “English (UK)” | [SW-555-002]; |
| “English (US)” | [SW-555-003]; |
| “Francais” | [SW-555-004]; |
| “Italiano” | [SW-555-005]; |
| “Espanol” | [SW-555-006]; |
| } | |

“Auto-Menu” is a key word. The next two lines stipulate that the selection menu applies to the versions 001 and 002 of the target-unit type HW-1001 and is displayed when the application “T2S” has been chosen.

After the user has chosen the voice output functionality, the menu file is read in from the CD and there is a search for T2S. A check is carried out to determine whether there is a target unit in version 001 or 002 of the type with the article number HW-1001 on board the vehicle.

By way of example, a target unit in version 001 is located on board. In that case, a selection menu containing the alternatives “Deutsch”-“English (UK)”-“English (US)”-“Francais”-“Italiano”-“Espanol” is constructed, the menu item “Cancel” stored in the central unit is added and all the menu items are displayed by the component for man/machine interaction. Depending on the user's selection, the software module is loaded which is linked to the selected language in the menu file. By way of example, the user selects “Deutsch” as the language for the voice output. The information about whether the software module SW-555-001 is approved for the target unit HW-1001-001 and about where the software module SW-555-001 is stored on the CD is then taken from the approval file.

The autostart file stores the information which stipulates which software modules are transferred if neither a set of software modules is prescribed by a configuration management system nor a user makes a selection. One example is illustrated by the syntax of this file:

{
[Do-Flash]
[HW-1001-001] SW-101-001 SW-111-001;
If HW-1102-00n AND [HW-2102-001 OR HW-2102-002] AND NOT
HW-2302-00n THEN [HW-1002-002] SW-101-001 SW-111-001
}

“Do-Flash” is a key word which starts the block with the information about the software modules which are to be transferred. The following two stipulations are made in this block:

If the vehicle contains a target unit of the type HW-1001-001, then first the software module SW-101-001 and then the software module SW-111-001 are transferred.

If the vehicle contains a target unit of the type HW-1001-002, then first the software module SW-1001-001 and then the software module SW-111-001 are transferred, but only if the logic condition between the key words IF and THEN is satisfied. The condition is satisfied if

a target unit of the type HW-1102 and in one of the versions 001 to 009

and a target unit of the type HW-2102 and in the version 001 or 002

and no target unit of the type HW-2302 which is in one of the versions 001 to 009.

For each software module, two files are also produced and stored, namely

a configuration file which stipulates which files are part of the software module, where these files are stored and in what order they are transferred,

and a security file which is used to recognize transfer errors and manipulations.

These two files are preferably stored at the storage location which is stipulated for the software module. For the software module with the article number SW-102 and the version number 001, this is the path /XY/USA/0S/V1 in the example above. Two examples explain the structure of these files.

The configuration file for the software module SW-102-001 comprises the following lines:

[SW-102-001]
/SETUP.EXE
/INFO.TXT
# executable files
/BIN/CONTROLER.EXE
/LIB/DRIVER.DLL
# files with data
/DATA/CONFIG.INI
/DATA/DB/DATA.DB2
/DATA/USER/USER.DAT

The stipulations of the storage locations in this file are path details relating to the storage location of the software module, in this example relating to /XY/USA/OS/V1. The stipulations are automatically compiled to form a complete path and file name, e.g. to form /XY/USA/OS/V1/DATA/USER/USER.DAT.

These lines stipulate that, during transfer of the software module SW-102-001, the files SETUP.EXE, INFO.TXT, CONTROLER.EXE, DRIVER.DLL, CONFIG.INI, DATA.DB2 and USER.DAT are transferred in this order.

One example of a security file for the software module with the article number SW-111 and the version number 001 is indicated below. The security file contains the following lines:

[SW-111-001];
# size in kbytes
Size 6764;
# check sum
CRC 4758A08C;
# signature for HW-1001-001
[HW-1001-001];
signature 85A47D238;
# signature for HW-1001-002
[HW-1001-002];
signature 9CA47D236;

These details stipulate the following: all the files of the software module are 6764 kbytes in size together. This statement is used, by way of example, for displaying progress during transfer. It is established how many kbytes have already been transferred, and the statement in the configuration file means that it is known how many kbytes need to be transferred altogether. The quotient indicates the work progress, which is displayed in the form of a bar, for example.

The CRC value, in this example the hexadecimal number 4758A08C, is checked, in particular, in order to establish whether no transfer error has occurred during transmission to the vehicle and storage on board the vehicle.

In this example, the software module is approved for two versions of target units, namely for versions 001 and 002 of the type HW-1001. Hence, two different signatures are produced and are stored in the file, namely one signature per version. The signature for a version is preferably produced by treating the version as a data stream and producing a hash value. Using a secret key, the signature is produced from this hash value. The signature is thus dependent on the software module and on the secret key. To produce the signature, 1024-bit encryption based on the algorithm from Rivest-Shamir-Adleman (RSA encryption) is used, for example.

Signatures are produced on a computer which is stringently protected against unauthorized access and against manipulations. By way of example, the supplier operates this computer and delivers the two versions and the two signatures to the manufacturer of the motor vehicle. Another embodiment involves the supplier delivering just the two versions to the manufacturer, and the manufacturer himself producing the signatures. By way of example, the manufacturer transmits the signatures to the supplier, and the supplier transfers the software modules to his target units and in so doing uses the signature for a check. A third embodiment involves a certified trust center producing the signatures and managing the secret keys.

A permanent, non-overwritable memory in the target unit stores a public key. The public key can be read out, but is protected both against inadvertent and intentional overwriting or corruption or erasure. Preferably, the supplier provides the target unit with the public key. The signature is checked following transfer and prior to installation of the software module using the public key. This check ensures that the software module comes from a trustworthy source and has not been corrupted or manipulated.

During transmission, software modules are examined for approval, if required are selected and the files of the selected software modules recognized as approved are transferred. In the example, software modules for the central unit and for the door control unit are transferred from a CD. The CD has been placed into a reader in the central unit beforehand. The central unit, the door control unit and a control device which regulates and monitors the transfer operation are connected to one another and to further units on board the vehicle by means of one or more data buses. The control device is not fitted on board the vehicle, but rather is connected to the data bus on board the vehicle for the transfer operation. A central configuration management system or a documentation system prescribes a set of software modules which is taken into account when selecting the software modules which need to be transferred.

For the communication between the units during transfer, use is preferably made of the “Keyword Protocol 2000” (KWP2000), which is standardized by ISO 14230-1 and ISO 15765-1 to 15765-4 and VDA 14230-1 to VDA-14230-3. Commands are coded in KWP2000 by hexadecimal numbers, e.g. the command “ReadEDUIdentification” (read out a type identifier for a target unit) is coded by $1A,86. Other transfer protocols are likewise suitable.

In the example below, the vehicle is in a workshop during the transfer. During transfer, the following sequence is run through:

The control device is connected to the vehicle. It ascertains a vehicle identification distinguishing the vehicle from all other vehicles from the manufacturer and puts all other units which are connected to the data bus into a diagnosis mode by sending a corresponding message by broadcast via the data bus. In this diagnosis mode, the units cannot be activated.

The control device ascertains the identification for any other unit which is connected to the data bus. This identification comprises the article number, the version number and, if required, a serial number for the unit. This is done by sending a request via the data bus and each unit putting its identification onto the data bus.

Next, the control device ascertains which software modules are already present on the target units on board the vehicle. This is also done by means of request and response via the data bus.

The control device ascertains the article number and the version number of the inserted CD by means of a request to the central unit. The reader in the central unit checks whether a CD has been inserted correctly. The central unit reads in the approval file. A parser installed in the central unit ascertains the article number and the version number of the inserted CD and transmits this information to the control device via the data bus.

The control device terminates the diagnosis mode on the other units.

The control device is connected to the central configuration management system. Using an intranet, for example, the control device transmits to the central system the article number and version number of the inserted CD and also the article numbers and version numbers of the target units and software modules ascertained on board the vehicle.

In this embodiment, the central configuration management system has read access to the information about which software modules are stored on the CD and which of these software modules are approved for which target-unit types. It transmits a second set of software modules to the control device. The software modules stated in this second set are subsequently transferred.

The control device is separated from the central configuration management system and is connected to the vehicle again.

The control device again ascertains the article number and the version number of the inserted CD by means of a request to the central unit. The fresh check allows for the possibility that the previously inserted CD has been replaced or removed in the meantime. If a different article number and version number are ascertained or it is established that no CD has been inserted, then a corresponding message is output in order to prompt insertion and reading-in of the correct CD.

The control device again puts all the other units on the data bus into a diagnosis mode.

The central unit is sent the article numbers and version numbers of the software modules intended for the central unit and also the serial number of the control device and the time of transfer. The central unit stores all of this information.

In this embodiment, the central unit is an “intelligent unit”. It acquires for itself the software modules which are intended for it, and also the configuration file and the security file for each of these software modules. To this end, it evaluates the information about the storage location, which the control device additionally transmits to the central unit if required.

If a particular software module is not found on the CD or cannot be read, the control device produces a corresponding error message.

The corresponding information is transmitted to the door control unit and is stored there. The door control unit likewise acquires for itself the software modules intended for it and also the configuration files and the security files.

The control device verifies that all the software modules which are intended for the central unit have actually been stored in the central unit, and does the same for the door control unit.

The control device prompts the central unit to check the security file's signature produced using the secret key with the aid of the public key, which is stored in the central unit. The central unit reports back the result of the check.

The control device prompts the central unit to check the CRC value. The central unit also reports back this result.

The signature and the CRC value are also checked for the door control unit, and the results are reported to the control device.

Signals are sent to the central unit and to the door control unit, prompting the units to store in memory cells the fact that and which new software modules have been transferred. The first signal is a reset flag. For each module, an activating flag is also set.

The diagnosis mode is terminated. Those units for which a reset flag has been set are powered down and are powered up again. In the present example, this is the central unit and the door control unit. The rest of the units on the data bus are temporarily deactivated. Upon powering up, the transferred software modules distinguished by an activating flag are installed and started.

The control device is connected to the central configuration management system again. It transmits to the central system the vehicle identification and also the article numbers and version numbers of the types of target units which have been ascertained on board the vehicle and of the software modules which have been successfully transferred to the vehicle.

A worker is required to place the CD into the reader and to remove it again when transfer is complete and also to connect the control device to the vehicle, to the central configuration management system and then to the vehicle again.

A software module may be split not just over a plurality of files but also over a plurality of segments, namely if the target unit is a memory-addressed unit based on the transfer protocol KWP2000, for example. If a software module is split over a plurality of segments, then the CD preferably stores a main header for the software module and the first segment, and a subheader for each further segment. For a software module having three segments, a main header and two subheaders are thus produced. The main header preferably comprises the following information:

start address for the memory area in the target unit in which the first segment is stored

compressed length of the first segment

uncompressed length of the first segment

article number of the software module

version number of the software module

total number of segments

version of the main header

further statement, e.g. type of software module

A subheader preferably comprises the following information:

start address for the memory area in the target unit which stores the further segment

compressed length of the further segment

uncompressed length of the further segment

what number segment is this further segment?

1-12. (Canceled)

13. A method for transferring software modules for target units which are fitted in a target apparatus, wherein the software modules are stored in a memory device, unit-type identifiers are stipulated for the target units, software-type identifiers are stipulated for the software modules, a data link is set up at least intermittently between the memory device and the target apparatus for the purpose of transferring software modules, and the unit-type identifiers and software-type identifiers are used to decide which of the software modules are transferred, the method comprising:
prescribing approval stipulations which use the unit-type identifiers and software-type identifiers to stipulate which software modules are approved for which target-unit types;
establishing the type of at least one target unit actually fitted at the time of the transfer;
checking at least one stored software module to determine whether the software module is approved for the type of the target unit which is actually fitted; and
transferring the software modules recognized as approved from the memory device to the target apparatus, wherein the target apparatus is a mobile apparatus including a vehicle or other mode of transportation, and the memory device is a mobile memory device.

14. The method as claimed in claim 13, further comprising:
using one or more similar mobile memory devices to transfer software modules to a plurality of mobile apparatuses having different target units.

15. The method as claimed in claim 14, further comprising:
storing software modules for target units from a first manufacturer at a first location on the mobile memory device;
storing software modules for target units from a second manufacturer at a second location on the mobile memory device;
combining approval stipulations for the software modules for target units from the first manufacturer with approval stipulations for the software modules for target units from the second manufacturer; and
storing the combined approval stipulations on the mobile memory device.

16. The method as claimed in claim 15, further comprising:
storing the approval stipulations on the mobile memory device.

17. The method as claimed in claim 16, further comprising:
storing the approval stipulations in a storage system, wherein the storage system includes a configuration management system or a documentation system;
controlling the transfer by a control device;
transmitting the approval stipulations from the storage system to the control device.

18. The method as claimed in claim 17, wherein the approval stipulations include at least one condition for the approval of a software module, the approval condition includes the presence or absence of particular target-unit types and/or of particular software modules on board the mobile apparatus, and the approval check involves checking the validity of the approval condition.

19. The method as claimed in claim 18, further comprising:
prescribing a set of software modules;
carrying out an approval check for each software module in the set; and
transferring each software module recognized as approved in the set from the mobile memory device to the mobile apparatus.

20. The method as claimed in claim 19, wherein the set is prescribed by virtue of particular software modules being distinguished on the mobile memory device.

21. The method as claimed in claim 20, wherein the set is prescribed by virtue of selected software modules being distinguished in the storage system, the transfer of the software modules being controlled by a control device, and the information about which software modules belong to the set being transmitted from the storage system to the control device.

22. The method as claimed in claim 21, wherein at least one target unit belongs to a voice-input or voice-output system, the mobile memory device stores software modules for various languages, and the set is prescribed by virtue of a language being selected.

23. The method as claimed claim 22, wherein the transfer is followed by ascertainment of which software modules have actually been transferred without error, and the storage system stores an exemplar identifier for the mobile apparatus, and the unit-type identifier for a target unit which is actually present and/or the software-type identifier for a software module transferred without error.

24. An apparatus for transferring software modules for target units which are fitted in a target apparatus comprising:
a reader for reading in software modules and approval stipulations from a mobile memory device, the approval stipulations using type identifiers for target units and for software modules to stipulate which of the software modules are approved for which target-unit types;
a control device for controlling the transmission of software modules from the mobile memory device to the mobile apparatus, a device for ascertaining unit-type identifiers for actually fitted target units; and
a device for checking which software modules are approved for which target units actually fitted on board the mobile apparatus, the checking device comprising means for evaluating the approval stipulations.
